(19) United States
(12) Patent Application Publication
(10) Pub. No.: US 2006/0190895 A1
(43) Pub. Date: Aug. 24, 2006

(54) Method and program for designing semiconductor device

(75) Inventor: Hirotaka Ishikawa, Kawasaki (JP)

Correspondence Address: YOUNG & THOMPSON, 745 SOUTH 23RD STREET, 2ND FLOOR, ARLINGTON, VA, 22202, US

(73) Assignee: NEC ELECTRONICS CORPORATION, KAWASAKI (JP)

(21) Appl. No.: 11/334,354

(22) Filed: Jan. 19, 2006

(30) Foreign Application Priority Data
Jan. 19, 2005 (JP) 2005-012128

(51) Int. Cl. G06F 17/50

(52) U.S. Cl. 716/10

(57) ABSTRACT

A method for designing a semiconductor device by using a computer, includes steps (a) to (b). The step (a) is the step of placing a power line and a ground line along a first direction. The step (b) is the step of placing a capacity cell which includes a bypass capacitor connected between the power line and the ground line. The step (b) includes (b1) placing plural kinds of element cells along a second direction perpendicular to the first direction. The capacity cell is composed of the plural kinds of element cells.

### BACKGROUND OF THE INVENTION

1. Field of the Invention

The present invention relates to a method and program for designing a semiconductor device. More specifically, the present invention relates to a method and a program for designing a semiconductor device having a bypass capacitor.

2. Description of the Related Art

In LSI designing, it is essential to use a computer to reduce time involved in designing and checking and eliminate human errors. Such a design system for a semiconductor device using a computer is called a CAD (Computer Aided Design) system. In a cell-based LSI design method, a plurality of cells is provided as a library. Using the CAD, the designer designs the LSI by executing placement of desired cells on the layout space defined in the computer. This provides layout data representing the configuration of the designed LSI.

A plurality of cells prepared as the library includes a “capacity cell”. This capacity cell includes a bypass capacitor for electrically connecting a power line with a ground line. Placement of such capacity cells permits designing a semiconductor device with suppressed EMI (Electromagnetic Interference) and suppressed voltage drop.

In conjunction with the above described capacity cells, Japanese Laid-Open Patent Application JP-P2001-189384A discloses the following semiconductor device. This semiconductor includes: a semiconductor substrate; a first wiring provided on the semiconductor substrate; a second wiring provided on the semiconductor substrate; and one or pluralities of capacity cells. Each of the pluralities of capacity cells includes a bypass capacitor for electrically connecting the first wiring with the second wiring. All portions other than the portion where circuit cells are placed are occupied by the capacity cells.

Japanese Laid-Open Patent Application JP-P2000-183286A discloses the following semiconductor integrated circuit. In this semiconductor integrated circuit, a functional block is composed of a plurality of kinds of and a plurality of primitive cells. The semiconductor integrated circuit includes a bypass capacitor for connecting a power line with a ground line in the certain primitive cell to which a periodically varied signal is supplied. This bypass capacitor is provided on the place adjacent to a gate circuit to which a periodically varied signal is supplied among a plurality of gate circuit included in the primitive cell.

Japanese Laid-Open Patent Application JP-P2004-55954A discloses the following semiconductor integrated circuit. This semiconductor integrated circuit is an ASIC type such as an embeded array and cell-based IC. The semiconductor integrated circuit includes power capacity cells and functional block cells. The power capacity cell has a decoupling capacity and a diffusion layer is shared for reducing EMI noise. The functional block cells can constitute circuits including a NAND, NOR and Flip Flop. When a circuit is changed such as a change of specifications, by only changing an interconnection layer, desired EMI noise reduction and re-workability can be obtained.

Generally, as shown in FIG. 1, in a cell-based semiconductor design technology using a computer, parallel lines called “ROWs” are defined in layout space. The ROWs are formed along a given direction. A basic cell (primitive cell) 100, such as an inverter and a NAND gate, is placed along any one of the ROWs. That is, the width h of the ROW is so defined as to be equal to the width of the basic cell.

A pair of a power line and a ground line is basically placed for one ROW. However, as shown in FIG. 1, in some cases, a power line 110 and a ground line 120 are required which are formed in the same direction as a ROW and also extend across a plurality of ROWs. For example, an analog device requires a special power line and a special ground line each having a width larger than that of the ROW. In some cases, in order to prevent voltage drop on the inner area of a chip, a thick power line and a thick ground line are required which extend longitudinally and laterally on the inner area. In FIG. 1, the width HV of the power line 110 and the width HG of the ground line 120 are larger than the width h of the ROW. The placement of a capacity cell (bypass capacitor) for a pair of such a power line 110 and a ground line 120 brings about the following problems.

Since a normal capacity cell cannot be used for the power line 110 and the ground line 120, it is required to prepare a capacity cell 130 dedicated for a specific line width. When the capacity cell 130 is placed on a given area by using a layout tool, it is required that the width of the ROW corresponding to the area is modified manually based on the width of the capacity cell 130. That is, this causes an increase in the number of design processes. Moreover, a basic cell can no longer be placed on the modified ROW.

Alternatively, after layout data is created through an automatic layout process, it may be possible to modify a mask data (GDS data) generated based on the layout data. That is, it may be possible to manually place the configuration corresponding to the capacity cell 130 on the mask data. This also causes an increase in the number of design processes. Moreover, in the case of the modification of the mask data, it is required to manage the relation between the layout data and the mask data.

As described above, the conventional technology has required the preparation and placement of a special capacity cell 130 based on the width of a power supply line (power line and ground line), which causes an increase in the design processes for a semiconductor device. Thus, a technology is needed which is capable of improving the efficiency in designing a semiconductor device.

### SUMMARY OF THE INVENTION

In order to achieve an aspect of the present invention, the present invention provides a method for designing a semiconductor device by using a computer, including: (a) placing a power line and a ground line along a first direction; and (b) placing a capacity cell which includes a bypass capacitor connected between the power line and the ground line, wherein the step (b) includes: (b1) placing plural kinds of element cells along a second direction perpendicular to the first direction, the capacity cell is composed of the plural kinds of element cells.

A width of the element cell is equal to that of the ROW. Also, the widths of the power line and ground line are integral multiple of that of the ROW. Therefore, the method can automatically deal with the various widths of the power line and ground line, by placing element cells corresponding to the width of the power line and ground line, without doing any special processing such as the preparation and placement of a special capacity cell.

### BRIEF DESCRIPTION OF THE DRAWINGS

The above and other objects, advantages and features of the present invention will be more apparent from the following description taken in conjunction with the accompanying drawings, in which:

FIG. 1 is a conceptual view showing a method for placing a capacity cell according to a conventional technology;

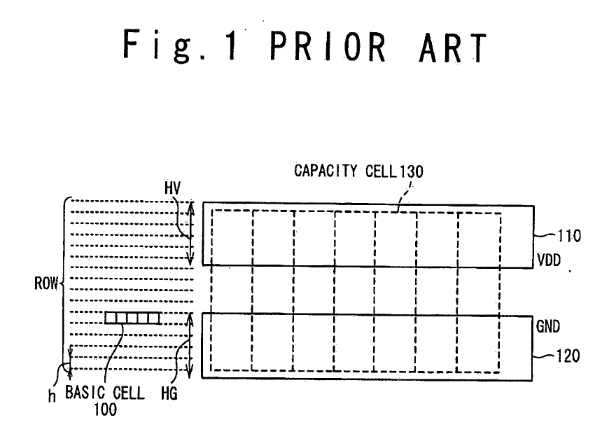

FIG. 2 is a conceptual view showing a method for placing a capacity cell according to the present invention;

FIG. 3 is a plan view showing a configuration of the capacity cell according to the present invention;

FIG. 4A is a sectional view showing the configuration of the capacity cell taken along line A-A′ of FIG. 3;

FIG. 4B is a sectional view showing the configuration of the capacity cell taken along line B-B′ of FIG. 3;

FIG. 4C is a sectional view showing the configuration of the capacity cell taken along line C-C′ of FIG. 3;

FIG. 4D is a sectional view showing the configuration of the capacity cell taken along line D-D′ of FIG. 3;

FIG. 5 is a schematic diagram showing a semiconductor device designed by using the capacity cell according to the present invention;

FIG. 6 is a block diagram showing the configuration of a semiconductor device designing system according to the present invention;

FIG. 7 is a flowchart showing a method for designing a semiconductor device according to the present invention; and

FIG. 8 is a flowchart showing an example of the method for placing the capacity cell according to the present invention.

### DESCRIPTION OF THE PREFERRED EMBODIMENTS

Embodiments of a method and a program for designing a semiconductor device and a semiconductor device designing system according to the present invention will be described below with reference to the attached drawings.

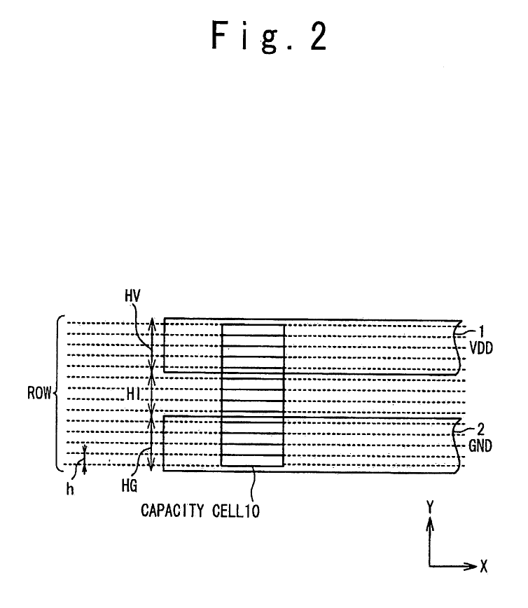

FIG. 2 is a conceptual view showing a method for placing a capacity cell according to the present invention. In a cell-based semiconductor design technology using a computer, layout space is first constructed in the memory. In this layout space, an X, Y, and Z directions are directions in parallel with mutually orthogonal axes. The X-Y plane corresponds to the plane parallel to the substrate surface. The Z direction is a direction perpendicular to the substrate surface. As shown in FIG. 2, parallel lines called “ROWs” along the X direction are defined in the layout space. The ROW is defined for placing a “basic cell”, a cell representing a logic device such as an inverter and a NAND. That is, the width h of each ROW along the Y direction is so set as to be equal to the width of the basic cell along the Y direction. The basic cell is placed along any one of the ROWs.

In this embodiment, a power line 1 (VDD) and a ground line 2 (GND) are placed, which are “thicker” than the width h of this ROW. More specifically, the power line 1 and the ground line 2 are placed along the X direction, i.e., in the same direction as a ROW. However, the width HV of the power line 1 in the Y direction is larger than the width h of the ROW. The width HG of the ground line 2 in the Y direction is also larger than the width h of the ROW. The interval (pitch) between the power line 1 and the ground line 2 is defined as HI. In this manner, the power line 1 and the ground line 2 are so placed as to extend across a plurality of ROWs.

A capacity cell 10 is placed which connects these power line 1 and ground line 2. This capacity cell 10 includes a bypass capacitor that electrically connects the power line 1 with the ground line 2. The bypass capacitor is used for suppressing EMI and voltage drop. That is, the capacity cell 10 is placed for designing a semiconductor device in which the EMI and voltage drop are suppressed.

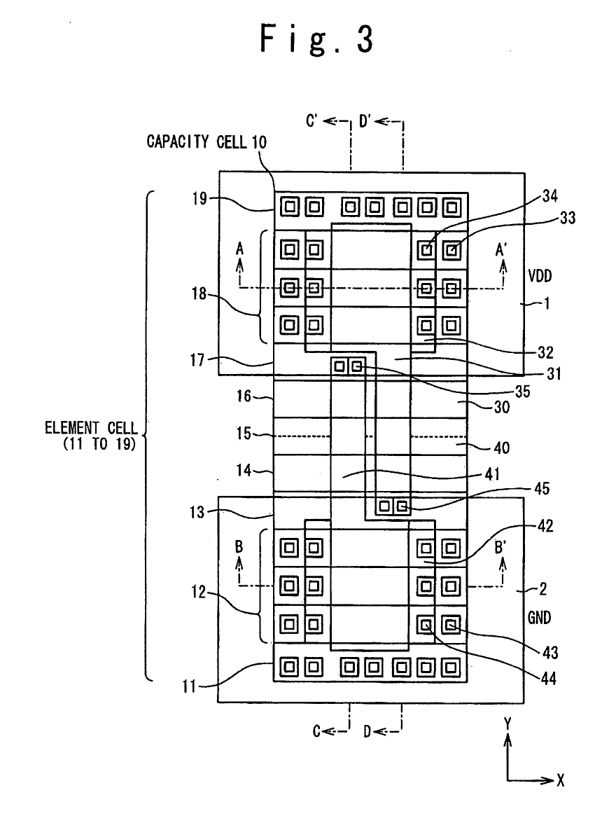

FIG. 3 is a plan view showing a configuration of the capacity cell according to the present invention. As shown in FIGS. 2 and 3, the capacity cell 10 is composed of a plural kinds of element cells 11 to 19. Each of these element cells 11 to 19 has a rectangular shape. The width of each of the plural kinds of element cells 11 to 19 in the Y direction is equal to the width h of the ROW. That is, the width of each element cell in the Y direction is equal to the width of the basic cell in the Y direction. Thus, each of the element cells 11 to 19 can be placed in the same manner as the basic cell.

The plural kinds of element cells 11 to 19 are aligned in the Y direction. Here, as shown in FIG. 3, the capacity cell 10 includes a plurality of second element cells 12 connected to the ground line 2 and a plurality of eighth element cells 18 connected to the power line 1. The plurality of second element cells 12 is placed repeatedly in succession in the Y direction. The plurality of eighth element cells 18 is also placed repeatedly in succession in the Y direction.

In another word, the capacity cell 10 covering a plurality of ROWs is divided into a plurality of portions for each ROW. In the plurality of portions, some have the same patterns that repeatedly appear. In the repeated portions, the portions connected to the ground line 2 are the second element cells 12, and the portions connected to the power line 1 are the eighth element cells 18. The number of repetitions of the second element cell 12 is determined by the width HG of the ground line 2. In the event of changing the width HG of the ground line 2, only this number of repetitions requires adjustment. The number of repetitions of the eighth element cell 18 is determined by the width HV of the power line 1. In the event of changing the width HG of the power line 1, only this number of repetitions requires adjustment. That is, the width of the capacity cell 10 according to the present invention is variable. Thus, the capacity cell 10 can easily be configured based on the width of the power line 1 and the ground line 2.

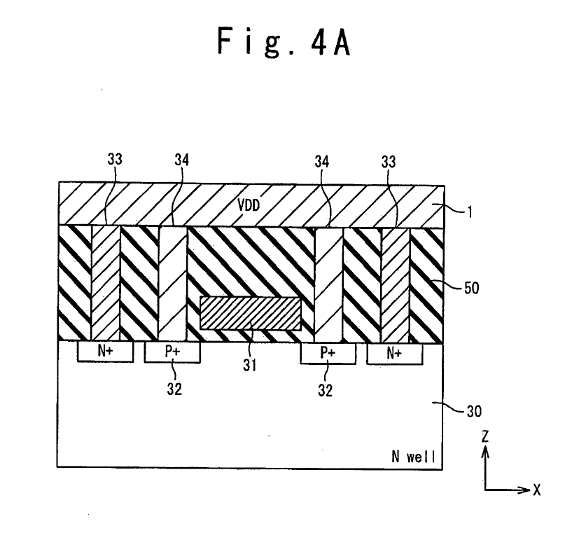

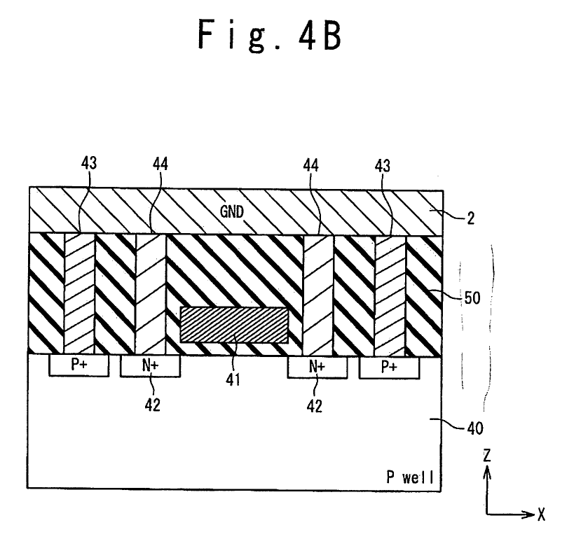

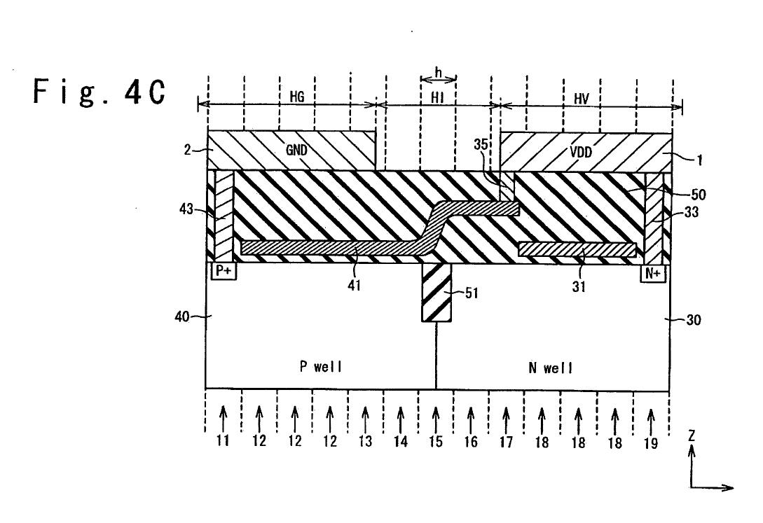

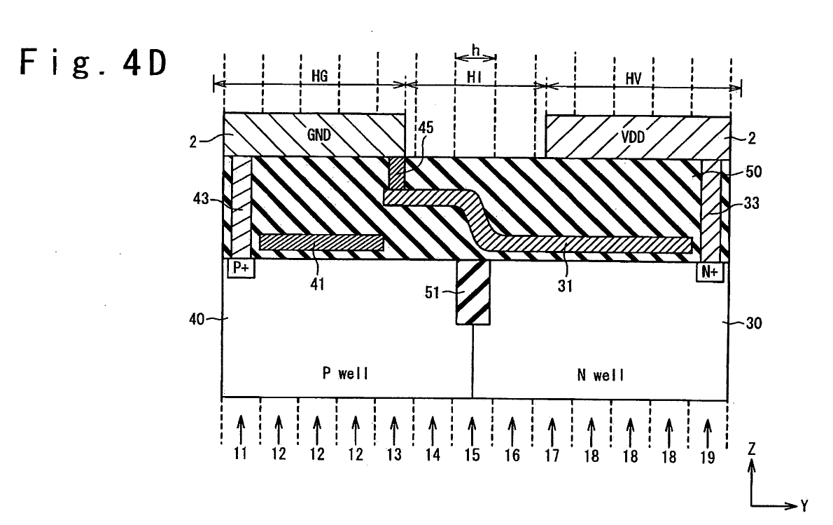

Hereinafter, the configuration of the bypass capacitor in this embodiment according to the present invention will be described below with reference to FIGS. 4A to 4D.

FIG. 4A is a sectional view showing the configuration of the capacity cell 10 taken along line A-A′ of FIG. 3. That is, FIG. 4A is a sectional view of the eighth element cell 18. As is the case with a normal P-channel MOS transistor, on an N well 30, a gate electrode 31 is formed with a gate insulating film therebetween. In the N well 30 of the both sides of the gate electrode 31, P-diffused layers 32 are formed. On the entire surface of the N well 30, an interlayer insulating film 50 is formed. On this interlayer insulating film 50, the power line 1 is formed. The power line 1 and the N well 30 are connected together via contacts 33 penetrating through the interlayer insulating film 50. The power line 1 and the P-diffused layers 32 are connected together via contacts 34 penetrating through the interlayer insulating film 50.

FIG. 4B is a sectional view showing the configuration of the capacity cell 10 taken along line B-B′ of FIG. 3. That is, FIG. 4B is a sectional view of the second element cell 12. As is the case with a normal N-channel MOS transistor, on a P well 40, a gate electrode 41 is formed with a gate insulating film therebetween. In the P well 40 of the both sides of the gate electrode 41, N-diffused layers 42 are formed. On the entire surface of the P well 40, an interlayer insulating film 50 is formed. On this interlayer insulating film 50, the ground line 2 is formed. The ground line 2 and the P well 40 are connected together via contacts 43 penetrating through the interlayer insulating film 50. The ground line 2 and the N-diffused layers 42 are connected together via contacts 44 penetrating through the interlayer insulating film 50.

FIG. 4C is a sectional view showing the configuration of the capacity cell 10 taken along line C-C′ of FIG. 3. Between the P-channel MOS transistor and the N-channel MOS transistor, a device insulation structure 51 is formed. As shown in FIG. 4C, the gate electrode 41 of the N-channel MOS transistor extends to the area below the power line 1 and is connected to the power line 1 via a contact 35. Thus, to the gate electrode 41 of the N-channel MOS transistor, a power potential VDD is applied. On the other hand, as shown in FIG. 4B, to the P well 40 and the N-diffused layers 42, a ground potential GND is applied via the contact 44. As a result, a bypass capacitor is formed.

FIG. 4D is a sectional view showing the configuration of the capacity cell 10 taken along line D-D′ of FIG. 3. As shown in FIG. 4D, the gate electrode 31 of the P-channel MOS transistor extends to the area below the ground line 2 and is connected to the ground line 2 via a contact 45. Thus, to the gate electrode 31 of the P-channel MOS transistor, a ground potential GND is applied. On the other hand, as shown in FIG. 4A, to the N well 30 and the P-diffused layers 32, a power potential VDD is applied via the contact 34. As a result, a bypass capacitor is formed.

As shown in FIGS. 4C and 4D, it can be understood that when the capacity cell 10 is divided into widths h along the Y direction, the same structure is repeated. To this repeatedly appearing structure, one kind of an element cell may be allocated. As described above, the second element cell 12 and the eighth element cell 18 are elements that can be repeatedly placed. Hereinafter, such element cells are each referred to as a “repeat cell”, and other cells are each refereed to as a “specific cell”.

The first element cell 11 is a specific cell corresponding to the end of the ground line 2. The second element cell 12 is a repeat cell corresponding to the ground line 2, and is repeatedly placed based on the width HG of the ground line 2. The third element cell 13 is a specific cell corresponding to an end of the N-diffused layers 42 and the contact 45. The fifth cell 15 is a specific cell corresponding to the boundary between the N well 30 and the P well 40. The fourth element cell 14 is a repeat cell that connects together the third element cell 13 with the fifth element cell 15. In this embodiment, only one fourth element cell 14 is placed, however, it may be placed repeatedly based on the interval HI between the power line 1 and the ground line 2.

The seventh element cell 17 is a specific cell corresponding to an end of the P-diffused layers 32 and the contact 35. The sixth element cell 16 is a repeat cell that connects together the seventh element cell 17 with the fifth element cell 15. In this embodiment, only one sixth element cell 16 is placed, but it may be placed repeatedly based on the interval HI between the power line 1 and the ground line 2. The eighth element cell 18 is a repeat cell corresponding to the power line 1 and is placed repeatedly based on the width HV of the power line 1. The ninth element cell 19 is a specific cell corresponding to the end of the power line 1.

As described above, according to the present invention, it is not required to prepare any special capacity cell. The capacity cell 10 is composed of a plurality kinds of element cells 11 to 19 each having the same width as that of the ROW. Therefore, each element cell can be placed in the same manner as the basic cell. Even in a case where the width HV of the power line 1 is larger than the width h of the ROW, the eighth element cell 18 can be placed repeatedly so as to correspond to the width HV of this power line 1. Moreover, even in a case where the width HG of the ground line 2 is larger than the width h of the ROW, the second element cell 12 can be placed repeatedly so as to correspond to the width HG of this ground line 2. Further, appropriately adjusting this number of repetitions permits achieving correspondence to the power line 1 and the ground line 2 having any widths. Furthermore, repeatedly placing the fourth element cell 14 and the sixth element cell 16 permits achieving correspondence to different widths HI.

According to the present invention, a plural kinds of element cells 11 to 19 that can be treated in the same manner as the basic cell are used instead of a special capacity cell. Therefore, it is no longer required to manually enlarge the width of the ROW and modify mask data, which have been conventionally practiced. This leads to an improvement in the efficiency in designing the semiconductor device. Moreover, it is not needed to forcibly enlarge the width of the ROW in the layout process. This leads to preventing a decrease of the area where the basic cell can be placed. Furthermore, it is not required to modify mask data. This leads to eliminating a management of the relation between layout data and mask data.

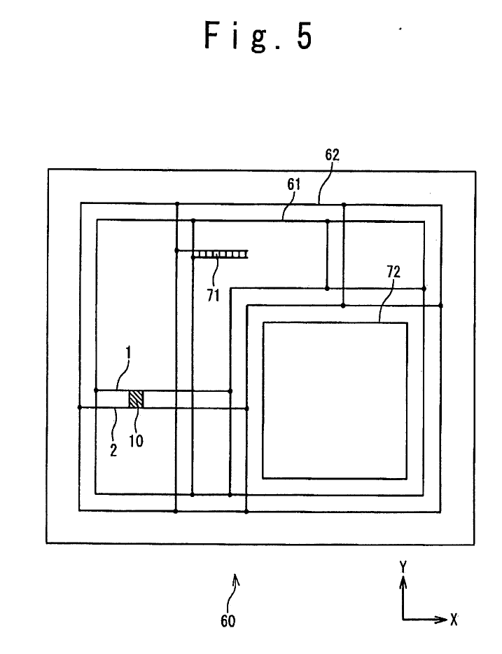

FIG. 5 is a schematic diagram showing an example of a semiconductor device to which the capacity cell 10 according to the present invention is applied. In this semiconductor device 60, a power line 61 and a ground line 62 are so placed as to surround the inner area thereof. In this inner area, basic cells 71 as logic devices, and a macro cell 72 such as a RAM are placed. Also around the macro cell 72, the power line 61 and the ground line 62 are placed. For one ROW, a thin power line and a thin ground line are basically placed. The basic cell 71 is connected to the thick power line 61 and the thick ground line 62 via the thin power line and the thin ground line. As shown in FIG. 5, such a thickpower line 61 and such a thickground line 62 are so formed as to extend longitudinally and laterally across the inner area for the purpose of, for example, preventing voltage drop in the inner area of the chip. The power line 1 and the ground line 2 described above are one kind of a thick power line 61 and a thick ground line 62, respectively, and, in particular, are formed along the X direction as is the case with the ROW. The capacity cell 10 according to the present invention is applied to such a power line. 1 and a ground line 2.

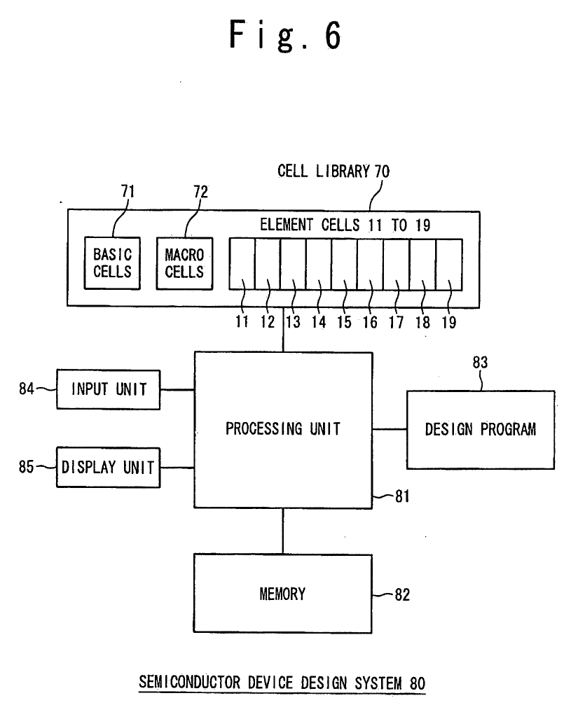

FIG. 6 is a block diagram showing a system (CAD) for designing this semiconductor device 60. This semiconductor device design system 80 includes a cell library 70, a processing unit 81, a memory 82, a design program 83, an input unit 84, and a display unit 85. The cell library 70 stores data representing a plurality of cells provided as a library. This plurality of cells includes basic cells 71 such as a NAND gate and the like, macro cells 72 such as a RAM and the like, and the element cells 11 to 19 according to the present invention. This cell library 70 is realized by, for example, a hard disc unit.

The memory 82 is used as a work area where layout is performed, in which a layout space is constructed. The processing unit 81 can access the cell library 70 and the memory 82. The design program (including automatic layout tool) 83 is a computer program executed by the processing unit 81. The input device 84 is exemplified by a keyboard and a mouse. The user (designer) can input various commands using the input unit 84 referring to information displayed on the display unit 85. With such a semiconductor device design program 80, layout data is created which represents the layout of the semiconductor device 60.

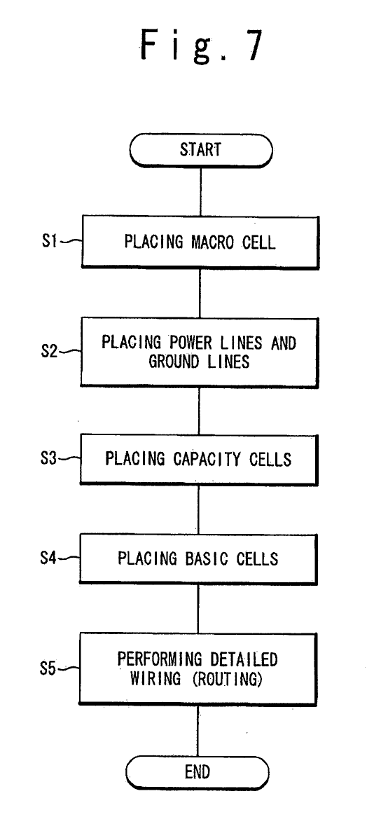

FIG. 7 is a flowchart showing a method for designing a semiconductor device, achieved by this semiconductor device design program 80. The processing unit 81 executes the following operation based on a command provided by the design program 83. First, the processing unit 81 constructs layout space in the memory 82. Next, the processing unit 81 reads data representing the macro cell 72 from the cell library 70. This macro cell 72 is, as shown in FIG. 5, placed at a predetermined position in the layout space (step S1). Subsequently, in the layout space, the power line and the ground line are placed (step S2). This step S2 includes placing (routing) power lines 1 and 61 and the ground lines 2 and 26.

Next, at a predetermined positions in the layout space, capacity cells are placed which connect together the power line 61 (including the power line 1) with the ground line 62 (including the ground line 2) (step S3). This step S3 includes placing the capacity cells 10 according to the present invention. That is, the processing unit 81 reads data representing the element cells 11 to 19 from the cell library 70. These element cells 11 to 19 are, as shown in FIG. 3, aligned along the Y direction in the layout space

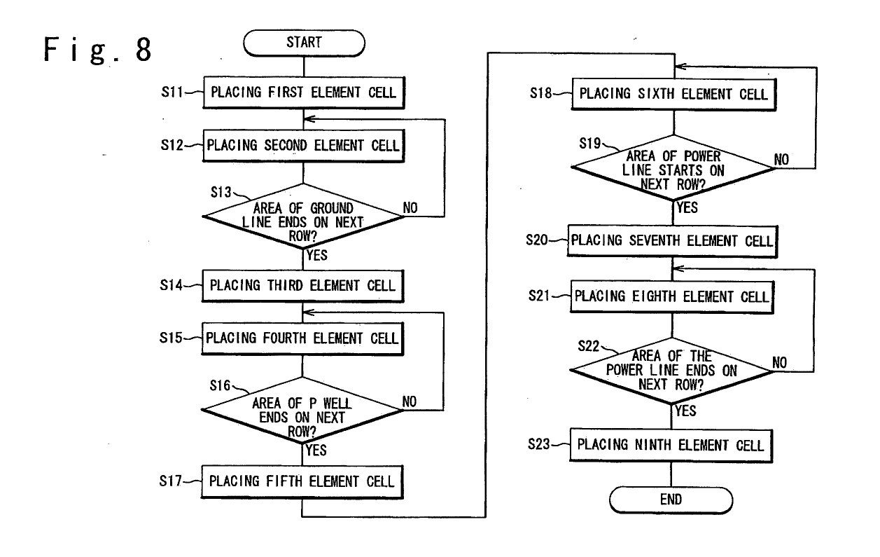

FIG. 8 is a flowchart showing one example of an algorithm for “automatically” placing the plurality of element cells 11 to 19 in step S3. Referring to FIG. 3, the first element cell 11 corresponding to the end of the ground line 2 is first placed (step S11). Subsequently, next to the first element cell 11, that is, on the adjacent ROW, the second element cell 12 corresponding to the ground line 2 is placed (step S12). On the next ROW, if the area of the ground line 2 still continues (step S13: NO), the step S12 is executed again. On the other hand, if the area of the ground line 2 ends on the next ROW (step S13: YES), the third element cell 13 is placed on this ROW (step S14). As a result, the second element cell 12 is repeatedly placed based on the width HG of the ground line 2.

Subsequently, next to the third element cell 13, that is, on the adjacent ROW, the fourth element cell 14 corresponding to the P well 40 is placed (step S15). If the entire next ROW still corresponds to the P well 40 (step S16: NO), step S15 is executed again. On the other hand, if the next ROW corresponds to an area where a change from the P well 40 to N well 30 occur (step S16: YES), the fifth element cell 15 is placed on this ROW (step S17). Subsequently, next to the fifth element cell 15, the sixth element cell 16 corresponding to the N well 30 is placed (step S18). On the next ROW, if the area of the power line 1 does not start (step S19: NO), step S18 is executed again. On the other hand, on the next ROW, if the area of the power line 1 starts (step S19: YES), the seventh element cell 17 is placed on this ROW (step S20) As a result, the fourth element cell 14 and the sixth element cell 16 are repeatedly placed based on the interval HI between the power line 1 and the ground line 2.

Subsequently, next to the seventh element cell 17, that is, on the adjacent ROW, the eighth element cell 18 corresponding to the power line 1 is placed (step S21). On the next ROW, if the area of the power line 1 still continues (step S22: NO), the step S21 is executed again. On the other hand, if the area of the power line 1 ends on the next ROW (step S22: YES), the ninth element cell 19 corresponding to the end of the power line 1 is placed on this ROW (step S23). As a result, the eighth element cell 18 is repeatedly placed based on the width HV of the power line 1.

Then, as shown in FIG. 7, from the cell library 70, data representing the basic cells 71 are read, and this read basic cells 71 are placed at a predetermined positions on the layout space (step S4). Then, detailed wiring (routing) is performed (step S5) In this process, cells are connected together as appropriate to provide a desired function.

In this manner, the layout data representing the layout of the semiconductor device 60 is created. At a stage for creating this layout data, it is not required to modify the width of the ROW. Moreover, mask data is created from this layout data, and it is not required to modify this mask data. Using this mask data, a semiconductor device can be actually manufactured.

The semiconductor device 60 manufactured has the following features. Each of the element cells 11 to 19 is so formed as to fit into one ROW. As shown in FIG. 3, the contacts (33 to 35, 43 to 45) do not overlap the boundaries between ROWs. The boundary between ROWs is a boundary between logic devices corresponding to the basic cell 71. When a given logic device is formed in an area between the first and second lines along the X direction, the contacts (33 to 35, 43 to 45) possessed by the bypass capacitor are so formed as not to overlap the first and the second lines.

As described above, the method for designing the semiconductor device according to the present invention permits placement of the capacity cell 10 by using an automatic layout tool based on the width of the power supply line (the power line 1 and the ground line 2). The method for designing the semiconductor device according to the present invention can support various widths of power supply lines. Moreover, with this design method, it is no longer required to add a process such as manual data modification, thus improving the efficiency in designing a semiconductor device.

In the embodiment described above, a description has been given referring to the element cells 11 to 13 and the contacts of 17 to 19 do not extend over the boundary of the ROW. However, the bypass capacitor may also be composed of element cells, adjacent ones of which share a contact. That is, element cells having a contact that extends across ROWs. For example, the element cells 11 and 12 may share a contact extending over the ROW, a boundary therebetween. In this case, as is the case with the example described above, the element cells 12 and 18 are repeated in the same pattern in the unit of ROW, and at least a contact extending over ROWs is repeatedly placed depending on the ROW. The present invention is not limited to the embodiment, and thus various modifications may be made without departing from the scope of technical ideas of the invention.

What is claimed is:

1. A method for designing a semiconductor device by using a computer, comprising:
(a) placing a power line and a ground line along a first direction; and
(b) placing a capacity cell which includes a bypass capacitor connected between said power line and said ground line,
wherein said step (b) includes:
(b1) placing plural kinds of element cells along a second direction perpendicular to said first direction, said capacity cell is composed of said plural kinds of element cells.

2. The method for designing a semiconductor device according to claim 1, wherein said plural kinds of element cells include first element cells which are connected to said power line, and
said step (b1) includes:
(b11) placing said first element cells corresponding to a width of said power line in said second direction.

3. The method for designing a semiconductor device according to claim 2, wherein said first element cells are successively placed along said second direction in said step (b11).

4. The method for designing a semiconductor device according to claim 1, wherein said plural kinds of element cells include second element cells which are connected to said ground line, and
said step (b1) includes:
(b12) placing said second element cells corresponding to a width of said ground line in said second direction.

5. The method for designing a semiconductor device according to claim 4, wherein said second element cells are successively placed along said second direction in said step (b12).

6. The method for designing a semiconductor device according to claim 1, wherein said plural kinds of element cells include third element cells which are placed between said power line and said ground line, and
said step (b1) includes:
(b13) placing said third element cells corresponding to a distance between said power line and said ground line in said second direction.

7. The method for designing a semiconductor device according to claim 6, wherein said third element cells are successively placed along said second direction in said step (b13)

8. The method for designing a semiconductor device according to claim 1, wherein a width of each of said plural kinds of element cells in said second direction is equal to a width of a basic cell in said second direction.

9. A computer program product, which includes a method for designing a semiconductor device, embodied on a computer-readable medium and comprising code that, when executed, causes a computer to perform the following:
(a) placing a power line and a ground line along a first direction; and
(b) placing a capacity cell which is connected between said power line and said ground line, and includes a bypass capacitor,
wherein said step (b) includes:
(b1) placing plural kinds of element cells along a second direction perpendicular to said first direction, said capacity cell is composed of said plural kinds of element cells.

10. The computer program product according to claim 9, wherein said plural kinds of element cells include first element cells which are connected to said power line, and
said step (b1) includes:
(b11) placing said first element cells corresponding to a width of said power line in said second direction.

11. The computer program product according to claim 10, wherein said first element cells are successively placed along said second direction in said step (b11).

12. The computer program product according to claim 9, wherein said plural kinds of element cells include second element cells which are connected to said ground line, and
said step (b1) includes:
(b12) placing said second element cells corresponding to a width of said ground line in said second direction.

13. The computer program product according to claim 12, wherein said second element cells are successively placed along said second direction in said step (b12).

14. The computer program product according to claim 9, wherein said plural kinds of element cells include third element cells which are placed between said power line and said ground line, and
said step (b1) includes:
(b13) placing said third element cells corresponding to a distance between said power line and said ground line in said second direction.

15. The computer program product according to claim 14, wherein said third element cells are successively placed along said second direction in said step (b13)

16. The computer program product according to claim 9, wherein a width of each of said plural kinds of element cells in said second direction is equal to a width of a basic cell in said second direction.

17. A semiconductor device designing apparatus comprising:
a first storage unit configured to store data indicating plural kinds of element cells;
a processing unit configured to electrically connected to said storage unit; and
a second storage unit configured to store a design program which is executed by said processing unit,
wherein a capacity cell, which is composed of said plural kinds of element cells, includes a bypass capacitor connected between said power line and said ground line,
said power line and said ground line are placed along a first direction, and
said processing unit reads out said data and places said plural kinds of element cells along a second direction perpendicular to said first direction.

18. The semiconductor device designing apparatus according to claim 17, wherein said plural kinds of element cells include first element cells which are connected to said power line, and
said processing unit places said first element cells corresponding to a width of said power line in said second direction.

19. The semiconductor device designing apparatus according to claim 17, wherein said plural kinds of element cells include second element cells which are connected to said ground line, and
said processing unit places said second element cells corresponding to a width of said ground line in said second direction.

20. A semiconductor device comprising:
a logic device configured to be formed in an area between a first line and a second line parallel to said first line;
a first power supply line configured to be formed larger than said area;
a second power supply line configured to be formed larger than said area; and
a bypass capacitor configured to electrically connect said first power supply line and said second power supply line,
wherein said bypass capacitor includes a contact which is connected to one of said first power supply line and said second power supply line, said contact is formed in said area such that said contact does not overlap said first line and said second line.
